(19) United States
(12) Patent Application Publication
(10) Pub. No.: US 2015/0014101 A1
(43) Pub. Date: Jan. 15, 2015

(54) ELEVATOR CAR DOOR DRIVE MECHANISM

(71) Applicant: Michael J. Tracey, Cromwell, CT (US)

(72) Inventor: Michael J. Tracey, Cromwell, CT (US)

(73) Assignee: Otis Elevator Company, Farmington, CT (US)

(21) Appl. No.: 14/373,680

(22) PCT Filed: Mar. 23, 2012
(86) PCT No.: PCT/US2012/030391

§ 371 Date: Jul. 22, 2014

(51) Int. Cl. B66B 13/08; B66B 19/00; B66B 13/12

(52) U.S. Cl. CPC B66B 13/08; B66B 13/12; B66B 19/00; B66B 19/007
USPC 187/319; 187/324; 29/401.1

(57) ABSTRACT

According to an aspect of the present invention, a door drive mechanism for actuating a door of an elevator car laterally between open and closed positions is provided. The door is mounted on the car for lateral movement relative to the car, and is connected to the car by at least one pivotable arm. The door drive mechanism includes a linear door drive mechanism and at least door drive mount. The door drive mechanism is configured to be mounted on the car. The door drive mount is configured to be attached to the door and is in communication with the linear door drive mechanism. The linear door drive mechanism is operable to selectively drive the door drive mount, the attached door, and the pivot arm between the open position and the closed position.

### BACKGROUND OF THE INVENTION

1. Technical Field

The present invention relates to elevator door operating mechanisms in general, and to elevator door operating mechanisms that utilize a pivoting arm in particular.

2. Background Information

An elevator car can be fitted with a plurality of different car door configurations for opening and closing an entry to the passenger compartment of the car; e.g., single door, two door center opening, single two-speed door, double two-speed door, etc. In many instances, the elevator door(s) is actuated by a door operating mechanism that includes a door linkage pivotable about a pivot mounted on the car. The door linkage is rotated about the pivot by a car door drive, causing the door to move laterally. The lateral movement of the car door opens and closes the entry way of the car. An example of a car door drive operable to rotate the door linkage includes a reciprocating door drive mechanism with a crank member extending between a rotatable crank gear and the door linkage. The rotatable crank gear is typically driven indirectly by the rotating shaft of an electric motor. Rotating the crank gear 180 degrees causes the door to travel from one of the open position to the closed position, or vice versa. The drive components utilized in such a configuration are typically complex, heavy, and require considerable maintenance.

FIG. 1 illustrates a prior art example of the above type of door operating mechanism in terms of a two speed door. In the configuration shown in FIG. 1, the door linkage 146 includes a primary arm 150 and a secondary arm 151. The primary arm 150 extends between a pivot 153 and the high speed door 155. The secondary arm 151 extends between the primary arm 150 and the slow speed door 156. The pivot 153 is mounted on a mast 157 attached to the car frame 56 located on top 144 of the car 28. A crank member 152 extends between a crank gear 158 and the primary arm 150. Rotating the crank gear 158 one hundred and eighty degrees (180°; e.g., from a 9:00 o'clock position to a 3:00 o'clock position) causes the crank member 152 to drive the primary and secondary arms 150,151, and therefore the attached doors 155,156, between the door open and closed positions. The door linkage 146 also cooperates with a car door/hoistway landing door coupler 65 in a manner such that the car door and the hoistway doors are driven together to open or close the entry to the elevator car 28. As indicated above, this type of door operating mechanism is typically complex, heavy, and requires considerable maintenance. The door operating mechanism shown in FIG. 1 is an example of one of several mechanisms known in the prior art that utilizes a pivoting door linkage.

### SUMMARY OF THE DISCLOSURE

According to an aspect of the present invention, a door drive mechanism for actuating a door of an elevator car laterally between open and closed positions is provided. The door is mounted on the car for lateral movement relative to the car, and is connected to the car by at least one pivotable arm. The door drive mechanism includes a linear door drive mechanism and at least door drive mount. The door drive mechanism is configured to be mounted on the car. The door drive mount is configured to be attached to the door and is in communication with the linear door drive mechanism. The linear door drive mechanism is operable to selectively drive the door drive mount, the attached door, and the pivot arm between the open position and the closed position.

According to another aspect of the present invention, an elevator system is provided. The elevator system includes a hoistway, an elevator car, and an elevator drive mechanism. The hoistway includes a plurality of landings, with each landing located at a different floor of a building. Each landing includes a hoistway door. The elevator car includes a door mounted for lateral movement on the car, at least one pivotable arm attached to the car and to the door, and a door drive mechanism. The door drive mechanism includes a linear door drive mechanism and at least one door drive mount. The linear door drive mechanism is mounted on the car. The door drive mount is attached to the door and in communication with the linear door drive mechanism. The linear door drive mechanism is operable to selectively drive the door drive mount, the attached door, and the pivot arm between the open position and the closed position. The elevator drive mechanism is operable to selectively move the elevator car vertically within the hoistway between the landings.

According to another aspect of the present invention, a method is provided for reconfiguring an elevator car. The elevator car includes at least one door mounted for lateral movement on the car, at least one pivotable arm attached to the car and to the door, at least one door coupler attached to the pivotable arm, and a reciprocating door drive mechanism mounted to the car. The reciprocating door drive mechanism includes a crank member attached between a crank gear and the pivotable arm. The method includes steps of: (a) disconnecting the reciprocating door drive mechanism from the car; (b) mounting a linear door drive mechanism to the car; and (c) attaching a door drive mount to the door and to the linear door drive mechanism; wherein the linear door drive mechanism is operable to selectively drive the door drive mount, the door, and the pivotable arm between an open position and a closed position. The method may also include a step of disconnecting the crank member from the pivotable arm.

In some embodiments of the present invention, the linear door drive is operable to move the pivotable aim in an arcuate manner to operate a door coupler where, for example, the door coupler requires an arcuate activation force.

In some embodiments of the present invention, the pivotable arm includes a primary arm portion and a secondary door portion, and the door includes a high speed door and a low speed door. The primary arm portion is configured to be attached to the high speed door and the car, and the secondary arm portion is configured to be attached to the primary arm portion and the slow speed door. During operation, selectively operating the linear door drive mechanism is operable to cause the primary arm portion and the secondary arm portion to move both the high speed door and the slow speed door at the same time.

In some embodiments of the present invention, the door drive mount is attached to the high speed door.

In some embodiments of the present invention, the linear door drive mechanism includes a drive motor, a first wheel, a second wheel, and a drive member in communication with the wheels. The drive motor is in communication with the first wheel and is operable to selectively rotate the drive member about the wheels in a first direction and a second direction, which second direction is opposite the first direction.

In some embodiments of the present invention, the door is a center opening door having a first side door portion and a second side door portion, and the at least one pivotable arm includes a first pivotable arm attached to the first side door portion and a second pivotable arm attached to the second side door portion. During operation of the door into the open and closed positions, the door drive mechanism causes the first side and second side door portions to move toward one another and away from one another, respectively. The at least one door drive mount includes a first door drive mount attached to the first side door portion, and a second door drive mount attached to the second side door portion.

The foregoing features and the operation of the invention will become more apparent in light of the following description and the accompanying drawings.

### BRIEF DESCRIPTION OF THE DRAWINGS

FIG. 1 is a diagrammatic partial front view illustration of an elevator car having a two-speed door and a prior art door drive mechanism.

FIG. 2 is a diagrammatic side view illustration of an elevator system arranged in a building hoistway.

FIG. 3 is a diagrammatic front view illustration of an elevator car that includes a plurality of car doors arranged in a closed position.

FIG. 4 is a diagrammatic front view illustration of the elevator car with the car doors arranged in an open position.

FIG. 5 is a diagrammatic sectional top view illustration of the car doors and a plurality of hoistway doors arranged in a closed position.

FIG. 6 is a diagrammatic sectional top view illustration of the car doors and the hoistway doors arranged in an open position.

FIG. 7 is a partial, diagrammatic front view illustration of an elevator car that includes a plurality of car doors in a closed position.

FIG. 8 is a flow diagram of a method for modifying an elevator car.

### DETAILED DESCRIPTION OF THE INVENTION

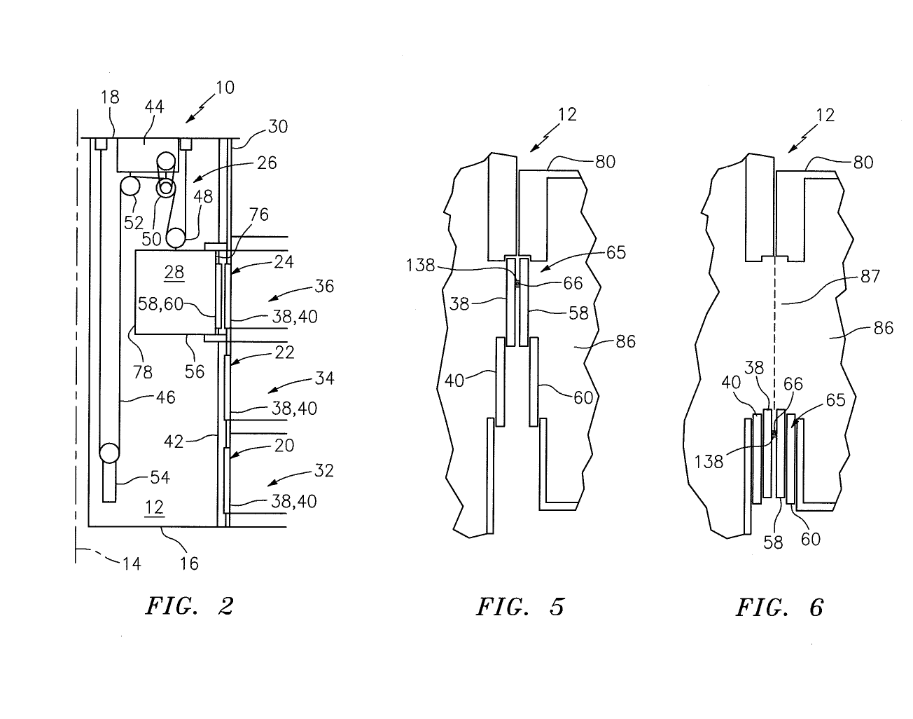

FIG. 2 illustrates an elevator system 10 includes an elevator car 28 arranged to travel within a building hoistway 12, an elevator drive mechanism 26 operable to drive the car 28 within the hoistway, and a plurality of landings 20, 22, 24, each located at a different floor 32,34,36 within the building at which the car may stop. The hoistway extends along an axis 14 (e.g., a vertical axis) between a bottom end 16 and a top end 18. Each landing includes a hoistway door(s) configured similarly to the door(s) of the car; e.g., the car and the landing may each have a two-speed door. For purposes of providing a detailed description of the present invention, the elevator car and the landings are described hereinafter in terms of a single two-speed door. The present invention is not, however, limited to a single two-speed door application and may be used on alternate elevator door configurations that utilize pivotable door linkages as will be described below.

The elevator drive mechanism 26 is configured to move the elevator car 28 vertically within the hoistway 12 (e.g., along one or more guide rails 42) between the landings 20, 22 and 24. The elevator drive mechanism 26 includes, for example, a motor 44 and a load bearing member 46 (e.g., ropes, belts, etc.). The drive member 46 is engaged with a plurality of sheaves 48, 50 and 52 and a counterweight 54. Examples of elevator drive mechanisms are disclosed in U.S. Pat. Nos. 7,905,332 and 7,428,950, each of which is hereby incorporated by reference in its entirety. The present invention, however, is not limited to any particular type of elevator drive mechanism.

Referring to FIGS. 3 and 4, the elevator car 28 includes an elevator car frame 56, a plurality of car doors (e.g., 58 and 60), a door linkage 62, a door drive mechanism 64, and a door coupler 65, that may include for example a fixed hoistway door engagement vane 66.

The car frame 56 extends heightwise between a bottom end 68 and a top end 70. The car frame 56 extends widthwise between a first car side 72 and a second car side 74. The car frame 56 also extends depthwise between a front side 76 and a back side 78 (e.g., see FIG. 2). The car frame 56 further includes a passenger compartment 80, a header 82 and a linkage mast 84. The passenger compartment 80 is defined by the ends 68,70 and the sides 72,74,76,78. The passenger compartment 80 includes an entry way 87 (see FIG. 4) that extends through the front side 76, for example, adjacent the first car side 72. The position of the entry way 87 may vary depending upon the car configuration. The header 82 extends heightwise between the passenger compartment 80 and a distal header end 88. The header 82 includes a door track 90 that is arranged on the front side 76 adjacent to the passenger compartment 80. The door track 90 extends widthwise between the first car side 72 and the second car side 74. The mast 84 is connected to the header 82, and extends heightwise to a distal end 81. The mast 84 includes a pivot 92 located, for example, proximate to the distal end 81 of the mast.

The car includes a high speed door 58 and a low speed door 60, one or more (e.g., roller or sliding) door hangers 94. The high speed door 58 includes a primary arm mount 93 and the low speed door 60 includes a secondary arm mount 95. The primary arm mount 93 and the secondary arm mount 95 may include any type of hardware that enables the respective arm to be pivotally attached to the respective door. The door hangers 94 mate with the door track 90 to slidably connect the doors 58 and 60 to the car frame 56.

The door linkage mechanism 62 includes at least one pivotable linkage arm that is configured to connect and synchronize movement (e.g., opening and closing) of the car doors 58 and 60. The door linkage mechanism 62 embodiment shown in FIGS. 3 and 4, for example, includes a pivotable arm that has a primary arm 98 and a secondary arm 100.

The primary arm 98 extends between a first end 102 and a second end 104. The primary arm 98 includes a door mounting segment 106, a linkage mounting segment 108, and a car mounting segment 110. The door mounting segment 106 extends from the first end 102 to the linkage mounting segment 108, and includes a fastener aperture 112 (e.g., an elongated slot) having a length. The linkage mounting segment 108 extends between the door mounting segment 106 and the car mounting segment 110, and includes a linkage mount 114 that connects the primary and secondary arms 98,100. The frame mounting segment 110 extends from the linkage mounting segment 108 to the second end 104, and includes a fastener aperture 116 (e.g., a bolt or stud hole). The present invention, however, is not limited to any particular first linkage arm configuration; e.g., mounts 93, 95, 114, pivot 92, aperture 112 could alternatively be mounted on the members with which they interact, and/or the specific configurations of the aims could assume different geometric configurations.

The second linkage arm 100 extends between a first end 118 and a second end 120. The second linkage arm 100 includes a second linkage mounting segment 122 and a second door mounting segment 124. The second linkage mounting segment 122 extends from the first arm end 118 to the second door mounting segment 124, and includes a third fastener aperture 126 (e.g., a bolt or stud hole). The second door mounting segment 124 extends from the second linkage mounting segment 122 to the second end 120, and includes a fourth fastener aperture 128; e.g., an elongated slot.

As indicated above, the present invention is primarily described herein in terms of a single two-speed door but is not limited thereto. For example, in alternative embodiments, the present invention can be implemented in a center opening door embodiment, wherein the door includes a first side door portion and a second side door portion that are operable to move away and toward one another when opening and closing, respectively. In this embodiment, the door linkage mechanism 62 would include a similar pivotable linkage arms for each door; e.g., the at least one pivotable arm would include a primary aim 98 and a secondary arm 100 for each door portion.

The door drive mechanism 64 is a linear door drive mechanism mounted to the car 28 (e.g., connected to the header 82) and at least one drive mount 96. The drive mount 96 may be a fixed bracket or linkage as illustrated in FIGS. 3 and 4, but is not limited thereto. In the embodiment shown in FIGS. 2 and 3, the door drive mechanism 64 includes a motor 130 (e.g., an electric step motor), and a door drive member 132 that is engaged with (e.g., wrapped around) a plurality of wheels; e.g., first wheel 134 and second wheel 136. Examples of a door drive member 132 include a belt, a cable, a rope, a chain, etc. which would cooperate with an appropriate type of wheel 134,136; e.g., sheaves, pulleys, sprockets, etc. In the embodiment shown in FIG. 3, the first wheel 134 is in communication with the motor 130 (e.g., via a drive member, a gear train, etc.) and is disposed on one side of the car (e.g., proximate the first car side 72). The second wheel 136 is disposed proximate the opposite side of the car; e.g., proximate the second car side 74. The drive mount 96, attached to the high speed door 58, is connected (e.g., clamped) to the door drive member 132.

Other examples of a linear door drive mechanism are disclosed in U.S. Pat. Nos. 7,202,615, 5,949,036, 5,701,973, and 5,659,160 and PCT Application No. PCT/BR2009/000193, each of which is hereby incorporated herein by reference in its entirety. The present invention, however, is not limited to any particular type and/or configuration of linear door drive mechanism.

The second linkage mount 93 mates with the first fastener aperture 112 to pivotally connect the primary arm 98 to the high speed door 58. The pivot 92 mates with the second fastener aperture 116 to pivotally connect the primary arm 98 to the mast 84. The second linkage mount 95 mates with the fourth fastener aperture 128 to pivotally connect the secondary arm 100 to the low speed door 60. The third linkage mount 114 mates with the third fastener aperture 126 to pivotally connect the secondary arm 100 to the primary arm 98. The hoistway door engagement vane 66 is connected to one of the doors (e.g., the high speed door 58).

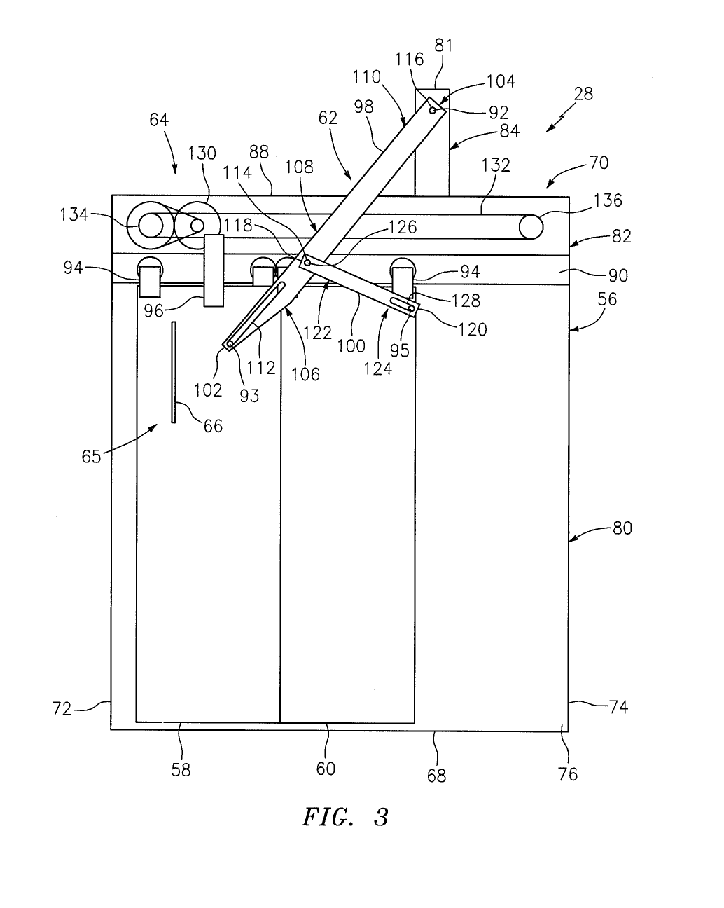

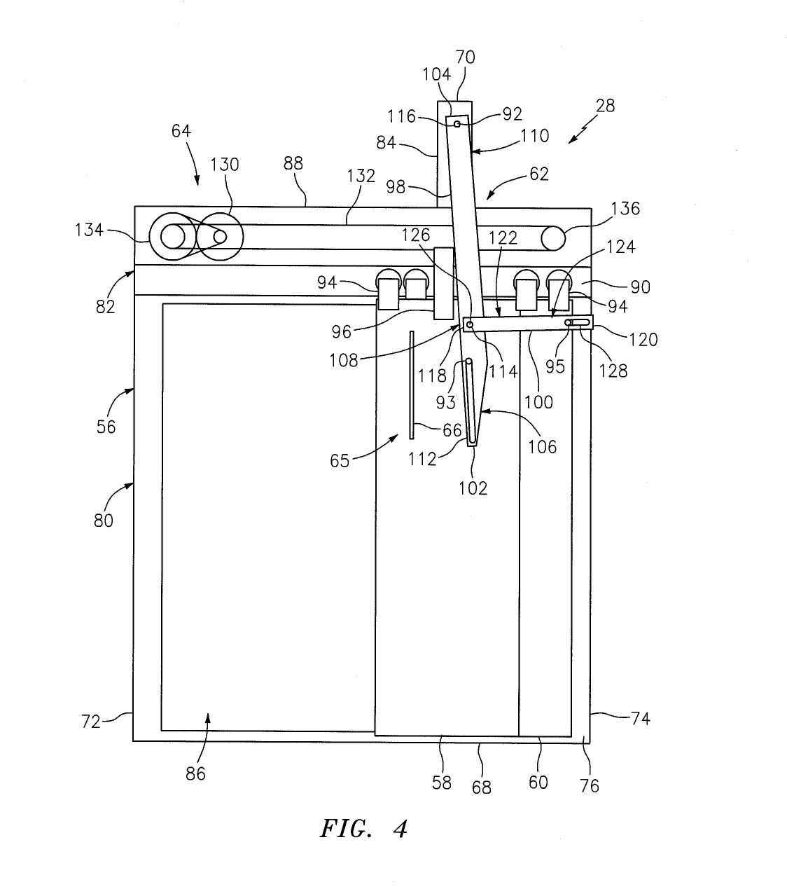

During operation, the door drive mechanism 64 selectively slides the car doors 58 and 60 laterally between a first (e.g., closed) position as shown in FIGS. 3 and 5, and a second (e.g., open) position as shown in FIGS. 4 and 6, and back. Referring to FIGS. 3 and 5, to open the doors 58, 60 and provide access to the car compartment 86, the motor 130 is operated to rotate the first wheel 134 and connected drive member 132 counter-clockwise. The drive mount 96 attached to the drive member 132 causes the high speed door 58 to move laterally in a first direction (e.g., towards the open position). As the high speed door 58 moves laterally, the primary arm 98 and the secondary arm 100 are rotated, thereby causing the slow speed door 60 to also move laterally in the first direction. To close the doors 58,60 and close access to the car compartment 86, the motor 130 is operated to rotate the door drive member 132 clockwise. The drive mount 96 attached to the drive member 132 causes the high speed door 58 to move laterally in a second direction (e.g., towards the closed position). As the high speed door 58 moves laterally, the primary arm 98 and the secondary arm 100 are rotated, thereby causing the slow speed door 60 to also move laterally in the second direction. In all aspects of the invention, the linear door drive mechanism 64 provides adequate force through the door drive mount(s) to drive the doors 58, 60 (and hoistway doors 38,40) laterally between the open and closed positions, as well as sufficient force to pivot the primary arm 98. Under the present invention, the primary arm 98 is passive in the sense that no force is applied to the arm from the door drive mechanism for the purposes of moving the doors between the open and closed positions.

Referring to FIGS. 5 and 6, the hoistway door engagement vane 66 couples with a corresponding car door engagement track 138 that is connected to the hoistway door 38. When the door drive mechanism 64 moves the car doors 58,60, the hoistway doors 38,40 are also driven laterally between the closed position shown in FIG. 5 and the open position shown in FIG. 6. In this manner, the car doors 58 and 60 and the respective hoistway doors 38 and 40 may be synchronously opened and closed. A variety of different mechanisms can be used to couple the car doors 58, 60 and the hoistway doors 38,40, and the present invention is not limited to use with any particular type of door coupler; e.g., fixed couplers, or coupler mechanisms that are actuated by the rotating movement of the primary arm 98. FIG. 7, for example, illustrates a coupling device that utilizes a pivoting mechanism attached to one end of the primary arm 98. As the primary arm 98 pivots, the coupler engages and disengages the hoistway and car doors.

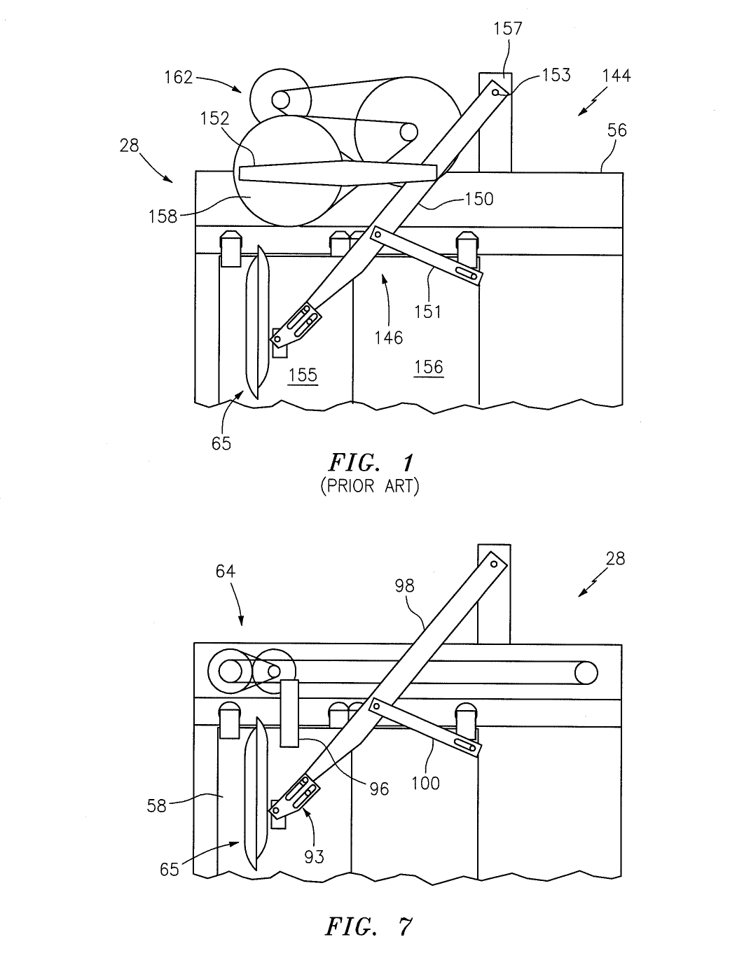

According to the present invention, a door drive mechanism is provided that can be implemented on new elevator cars, or implemented on existing elevator cars as a retrofit. To illustrate the invention in terms of a retrofit application, FIG. 1 illustrates a prior art elevator car having a two speed door operating mechanism. As indicated above, the door linkage includes a primary arm 150, a secondary arm 151, a rotatable shaft motor for rotating a crank gear 158, belts and pulleys, and a crank member 152. The crank member 152 extends between the crank gear 158 and the primary arm 150. Rotation of the crank gear 158 via the motor, causes the crank member 152 to translate laterally, and consequently causes rotation of the primary arm 150. Rotation of the primary arm 150 causes the attached doors 155,156, to move between open and closed positions. As indicated above, this type of door operating mechanism is typically complex, heavy, and requires considerable maintenance. Under the retrofit application of the present invention, the reciprocating door drive mechanism 162 consisting of the motor, crank gear 158, belts, pulleys, and crank member 152, is replaced with a door drive mechanism 64 that includes a linear door drive mechanism and at least one drive mount 96. The present invention door drive mechanism 64 is relatively simple, lightweight, and low maintenance. In addition, the present invention door drive mechanism can be implemented with the existing elevator car door/hoistway door couplers and locks if desired. Hence, the present invention door drive mechanism permits a significant upgrade to the elevator car without necessitating replacement of the coupler and/or lock at each landing of the hoistway.

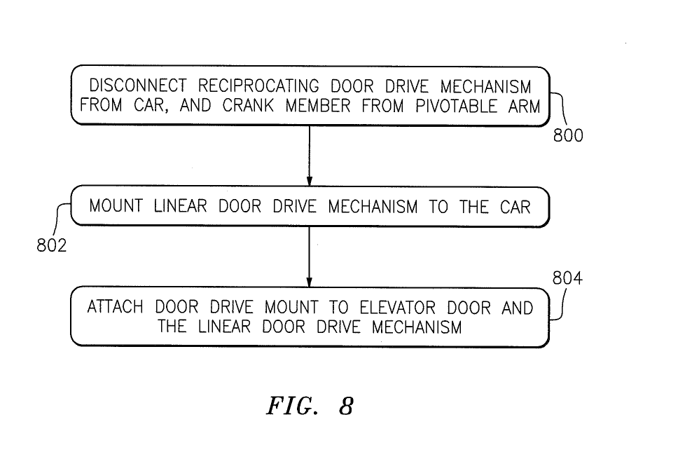

FIG. 8 is a flow diagram of a method for modifying (e.g., retrofitting) an elevator car 28, for example, as shown in FIG. 1. In step 800, the reciprocating door drive mechanism 162 is disconnected from the car 28, and the crank member 152 is disconnected from the primary arm 150. Referring now to FIGS. 7 and 8, in step 802, a replacement (e.g., new or refurbished) door drive mechanism such as, for example, the door drive mechanism 64 is mounted to the car 28. In step 804, a door drive mount such as, for example, the door drive mount 96 is attached to the high speed door 58 and to the door drive mechanism 64. As is clear from the above description, the present invention includes a modification system and method for replacing existing rotary door drive mechanisms with linear drive systems. The disclosed modification systems and methods allow for the replacement of a reciprocating door drive without requiring replacement of any existing couplers or locks. This can provide a clear benefit in both cost (it is not necessary to replace functioning components) and practicality (it is often difficult to replace existing locks and couplers due to regulations and/or the unavailability of compatible components). As further disclosed, various embodiments of the current invention allow for the linear drive to apply a sufficient linear opening force to the elevator doors to pivot a primary arm that is then able to activate the associated coupler(s) and/or lock(s) that require an arcuate activation source.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined within any one of the aspects and remain within the scope of the invention. To give a specific example, embodiments of the present invention are described above as having a door drive mount attached to the high speed door portion of a two-speed car door. Other embodiments are described as having a linear door drive that includes a pair of wheels and a drive member. Any of the aspects of the invention may include both of these features and more within the scope of the invention. This specific example should not be construed as limiting, and other combinations of described features are contemplated. Accordingly, the present invention is not to be restricted except in light of the attached claims and their equivalents. Furthermore, it is understood that the disclosed features of the various embodiments of the present invention described above may be combined with one another across the disclosed embodiments unless such a combination renders the system or method inoperable.

What is claimed is:

1. A door drive mechanism for actuating a door of an elevator car laterally between open and closed positions, which door is mounted on the car for lateral movement relative to the car and which door is connected to the car by at least one pivotable arm, the drive mechanism comprising:
a linear door drive mechanism configured to be mounted on the car; and
at least one door drive mount configured to be attached to the door and in communication with the linear door drive mechanism;
wherein the linear door drive mechanism is operable to selectively drive the door drive mount, the attached door, and the pivot aim between the open position and the closed position.

2. The door drive mechanism of claim 1, wherein the linear door drive is operable to move the pivotable arm in an arcuate manner to operate a door coupler.

3. The door drive mechanism of claim 2, wherein the pivotable arm includes a primary arm portion and a secondary door portion, and the door includes a high speed door and a low speed door, and the primary arm portion is configured to be attached to the high speed door and the car, and the secondary arm portion is configured to be attached to the primary arm portion and the slow speed door, and wherein selectively operating the linear door drive mechanism is operable to cause the primary arm portion and the secondary arm portion to move both the high speed door and the slow speed door at the same time.

4. The door drive mechanism of claim 3, wherein the door drive mount is attached to the high speed door.

5. The door drive mechanism of claim 4, wherein the linear door drive mechanism includes a drive motor, a first wheel, a second wheel, and a drive member in communication with the wheels, wherein the drive motor is in communication with the first wheel and is operable to selectively rotate the drive member about the wheels in a first direction and a second direction, which second direction is opposite the first direction.

6. The door drive mechanism of claim 1, wherein the door is a center opening door having a first side door portion and a second side door portion, and the at least one pivotable arm includes a first pivotable arm attached to the first side door portion and a second pivotable arm attached to the second side door portion; and
wherein during actuation of the door into the open and closed positions, the door drive mechanism causes the first side and second side door portions to move toward one another and away from one another, respectively; and
wherein the at least one door drive mount includes a first door drive mount attached to the first side door portion, and a second door drive mount attached to the second side door portion.

7. An elevator system, comprising:
a hoistway that includes a plurality of landings, each landing located at a different floor of a building, and each landing including a hoistway door;
an elevator car including a door mounted for lateral movement on the car, at least one pivotable arm attached to the car and to the door, and a door drive mechanism including a linear door drive mechanism and at least one door drive mount, wherein the linear door drive mechanism is mounted on the car, and the door drive mount is attached to the door and in communication with the linear door drive mechanism, wherein the linear door drive mechanism is operable to selectively drive the door drive mount, the attached door, and the pivot arm between the open position and the closed position; and
an elevator drive mechanism operable to selectively move the elevator car vertically within the hoistway between the landings.

8. The elevator system of claim 7, wherein the linear door drive is operable to move the pivotable arm in an arcuate manner to operate a door coupler.

9. The elevator system of claim 8, wherein the pivotable at it includes a primary arm portion and a secondary door portion, and the door includes a high speed door and a low speed door, and the primary arm portion is attached to the high speed door and the car, and the secondary arm portion is attached to the primary arm portion and the slow speed door, and wherein selectively operating the linear door drive mechanism causes the primary arm portion and the secondary arm portion to move both the high speed door and the slow speed door at the same time.

10. The elevator system of claim 9, wherein the door drive mount is attached to the high speed door.

11. The elevator system of claim 10, wherein the linear door drive mechanism includes a drive motor, a first wheel, a second wheel, and a drive member in communication with the wheels, wherein the drive motor is in communication with the first wheel and is operable to selectively rotate the drive about the wheels in a first direction and a second direction, which second direction is opposite the first direction.

12. The elevator system of claim 8, wherein the door is a center opening door having a first side door portion and a second side door portion, and the at least one pivotable arm includes a first pivotable arm attached to the first side door portion and a second pivotable arm attached to the second side door portion; and
wherein during actuation of the door into the open and closed positions, the door drive mechanism causes the first side and second side door portions to move toward one another and away from one another, respectively; and
wherein the at least one door drive mount includes a first door drive mount attached to the first side door portion, and a second door drive mount attached to the second side door portion.

13. The elevator system of claim 7, including a coupler for coupling the elevator car door to the hoistway door when the elevator car is located at one of the landings.

14. The elevator system of claim 13, wherein the coupler is actuable by rotation of the pivot arm.

15. A method for modifying an elevator car that includes at least one door mounted for lateral movement on the car, at least one pivotable arm attached to the car and to the door, at least one door coupler attached to the pivotable arm, and a reciprocating door drive mechanism mounted to the car, which reciprocating door drive mechanism includes a crank member attached between a crank gear and the pivotable arm, the method comprising:
disconnecting the reciprocating door drive mechanism from the car;
mounting a linear door drive mechanism to the car; and
attaching a door drive mount to the door and to the linear door drive mechanism;
wherein the linear door drive mechanism is operable to selectively drive the door drive mount, the door, and the pivotable arm between an open position and a closed position.

16. The method of claim 15, wherein the pivotable arm includes a primary arm portion and a secondary door portion, and the door includes a high speed door and a low speed door, and the primary arm portion is attached to the high speed door and the car, and the secondary arm portion is attached to the primary arm portion and the slow speed door, and wherein selectively operating the linear door drive mechanism causes the primary arm portion and the secondary arm portion to move both the high speed door and the slow speed door at the same time.

17. The method of claim 16, wherein the door drive mount is attached to the high speed door.

18. The method of claim 15, further comprising disconnecting the crank member from the pivotable arm.

19. The method of claim 15, wherein the door coupler requires an arcuate activation force and the linear door drive is operable to force the pivotable arm to move in an arcuate manner sufficient to operate the door coupler.
